(19) United States
(12) Patent Application Publication
(10) Pub. No.: US 2010/0151126 A1
(43) Pub. Date: Jun. 17, 2010

(54) SUBSTRATE COATING METHOD AND SUBSTRATE COATING APPARATUS

(75) Inventors: Tomohiro ISEKI, Koshi City (JP); Kentaro YOSHIHARA, Koshi City (JP); Tomohiro NODA, Koshi City (JP); Kousuke YOSHIHARA, Koshi City (JP)

Correspondence Address: CANTOR COLBURN, LLP, 20 Church Street, 22nd Floor, Hartford, CT, 06103, US

(73) Assignee: TOKYO ELECTRON LIMITED, Tokyo (JP)

(21) Appl. No.: 12/638,418

(22) Filed: Dec. 15, 2009

(30) Foreign Application Priority Data
Dec. 16, 2008 (JP) 2008-319412
Jan. 30, 2009 (JP) 2009-019460

(51) Int. Cl. B05D 1/40; B05C 5/02

(52) U.S. Cl. 427/240; 118/695

(57) ABSTRACT

There are provided a substrate coating method and a substrate coating apparatus to achieve the uniformity of a coating-liquid film and the improvement of the yield by inhibiting the bubbles generated during the application of a coating liquid. Also, there are provided a substrate coating method and a substrate coating apparatus to achieve the effective availability of the coating liquid and the uniformity of the coating-liquid film.

According to one example, a substrate coating method includes forming a liquid pool of deionized water by rotating the substrate at low speed of a first rotation speed and supplying deionized water to the center of the substrate, mixing the water-soluble coating liquid with the deionized water by supplying the coating liquid to the center of the substrate in a state where the substrate is rotated at the first rotation speed, and forming the coating-liquid film by rotating the substrate at a second rotation speed higher than the first rotation speed.

According to another example, a substrate coating method includes forming a liquid pool of the deionized water by rotating the substrate at low speed of a first rotation speed and supplying deionized water to the center of the substrate, mixing the water-soluble coating liquid with the deionized water by supplying the coating liquid to the center of the substrate in a state where the substrate is rotated at the first rotation speed, and forming the coating-liquid film by rotating the substrate at a second rotation speed higher than the first rotation speed. The discharge of the coating liquid (TARC) is set by controlling the time ratio of mixing the coating liquid with the deionized water to forming the coating-liquid film to be within a range of 1:3 to 3:1.

This application is based on and claims priority from Japanese Patent Application Nos. 2008-319412 and 2009-019460, filed on Dec. 16, 2008 and Jan. 30, 2009, respectively, with the Japanese Patent Office, the disclosure of which is incorporated herein in its entirety by reference.

### TECHNICAL FIELD

The present disclosure relates to a substrate coating method and a substrate coating apparatus for a substrate, such as a semiconductor wafer or a liquid crystal glass substrate (an FPD substrate).

### BACKGROUND

In a fabrication process of a semiconductor device, a photolithography technology is generally used for forming the circuit pattern by the application of a resist liquid on a substrate, such as a semiconductor wafer or an FPD substrate, and the exposure of a mask pattern. In this photolithography technology, the resist liquid is applied on the substrate by a spin coating method, a resist film formed by the application is exposed with a circuit pattern, and a circuit pattern is formed on the resist film by developing the exposed pattern.

Recently, an increase of exposure resolution in such a photolithography process has been requested as a device pattern becomes finer and thinner. There has been known an immersion exposure method as one method for increasing the resolution of exposure, which performs exposure in a state where a light-transmissive immersion liquid layer is formed on the surface of a wafer for improving a conventional exposure technology using a conventional light source, such as argon fluoride (ArF) or krypton fluoride (KrF). This immersion exposure technology is based on the transmission of light in water, such as deionized water, which uses a characteristic that the wavelength (193 nm) of ArF substantially becomes 134 nm in water since a wavelength is shortened in water.

In other words, in the immersion exposure technology, in a state where a immersion liquid layer (a liquid film) is formed between a lens and a wafer surface, light generated from a light source passes through the lens and the liquid film and irradiates to a wafer, thereby imprinting a resist pattern (a circuit pattern) to a resist. Then, in a state where the liquid film is formed between the lens and the wafer, an exposure means and the wafer slide horizontally relative to each other, so that the corresponding exposure means is disposed at a position corresponding to the next imprinting area (shot region), and then light irradiation is carried out. Through repetition of these processes, circuit patterns are imprinted in order on the wafer surface.

In this immersion exposure technology, the linewidth precision of the imprinted circuit pattern is reduced since a portion of resist components (even though it is a small amount) from the surface portion of the resist layer is eluted to form a liquid film (an immersion liquid layer) between the lens and the wafer surface and the eluted components are adhered to the surface of the lens. Also, even if the components are not adhered to the surface of the lens, the inclusion of the eluted components in the liquid film may have an influence on a refractive index of light. This may cause degradation of resolution and non-uniformity of linewidth precision on the surface.

Moreover, as a device pattern becomes finer, the effect of interference in a resist layer causes degradation of resolution and non-uniformity of linewidth precision on the surface.

There has been used another technology for supplying (applying) another water-soluble coating liquid, such as a TARC (Top Anti-Reflective Coating) chemical liquid, to a surface of a substrate formed with a resist layer to form an anti-reflective film (a protective film), thereby inhibiting the elution of a resist during immersion exposure or inhibiting the interference in a resist layer. Also, the TARC chemical liquid contains a surfactant having a function of reducing free energy of an interface (an interfacial tension) according to the balance between a hydrophilic group and a hydrophobic group within a molecule.

Also, in a substrate coating method for forming a coating film by supplying a coating liquid on the surface of a substrate, there has been generally used a so-called spin coating method for applying the coating liquid on the wafer by supplying the coating liquid from a nozzle to the center of a rotating wafer and diffusing the coating liquid on the wafer by a centrifugal force. In the spin coating method, there has been known a method for uniformly applying a coating liquid in a small amount, in which a solvent of the coating liquid is supplied on a wafer to perform a pre-wetting process, and then the rotation of the wafer is accelerated to a first rotation speed and the coating liquid is supplied to the rotating wafer. The rotation is decelerated to a second rotation speed to adjust film thickness of the coating liquid on the wafer, and the rotation is accelerated again to a third rotation speed to shake off the coating liquid on the wafer and dry the wafer. For example, see the claims of Japanese Patent Publication No. 3330324.

When a water-soluble coating liquid (a TARC chemical liquid) is applied on a wafer by using the spin coating method, deionized water, as a solvent of the coating liquid, may be supplied on the wafer during the pre-wetting process.

However, the TARC chemical liquid contains gas dissolved by pressurization or surfactant, thereby has a very high foamability. Thus, when the TARC chemical liquid is applied on a wafer, fine bubbles may easily occur. Accordingly, in spin coating of the TARC chemical liquid, the bubbles cause a coating defect (coating stain) of a coating film (TARC film), thereby reducing the yield of the device.

Also, after pre-wetting by the supply of deionized water as a solvent of a coating liquid on a wafer, when the rotation of the wafer is accelerated to a first rotation speed and then is decelerated to a second rotation speed, the effect of the pre-wetting is reduced. This is because the deionized water is formed into droplets just after spreading on a hydrophobic wafer due to high surface tension of the deionized water. Accordingly, in spin coating of the TARC chemical liquid, the droplets cause a coating defect (coating stain) on a coating film (TARC film).

### SUMMARY

According to one embodiment, there is provided a substrate coating method to form a coating-liquid film by supplying a water-soluble coating liquid on a substrate. The substrate coating method includes forming a liquid pool of deionized water by rotating the substrate at low speed of a first rotation speed and supplying deionized water to the center of the substrate, supplying the water-soluble coating liquid to the center of the substrate and mixing the coating liquid with the deionized water in a state where the substrate is rotated at the first rotation speed, and forming the coating-liquid film by rotating the substrate at a second rotation speed higher than the first rotation speed.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a schematic plan view illustrating an entire processing system including a substrate coating apparatus according to the present disclosure, a developing apparatus, and an exposure device connected to the substrate coating apparatus and developing apparatus.

FIG. 2 is a schematic front view illustrating the processing system.

FIG. 3 is a schematic rear view illustrating the processing system.

FIG. 4 is a schematic longitudinal-sectional view illustrating one example of a substrate coating apparatus according to the present disclosure.

FIG. 5 is a schematic cross-sectional view illustrating the substrate coating apparatus.

FIG. 6 is a flowchart illustrating main coating processes in a substrate coating apparatus.

FIG. 7 is a graph illustrating a rotation speed of a wafer and a supply timing of a coating liquid and deionized water in each coating process.

FIG. 8 shows schematic cross-sectional views illustrating the state of a liquid film on a wafer in each coating process.

FIG. 9 is another flowchart illustrating main coating processes in a substrate coating apparatus.

FIG. 10 is another graph illustrating a rotation speed of a wafer and a supply timing of a coating liquid and deionized water in each coating process.

FIG. 11 is another graph illustrating the thickness of a coating film on a wafer according to a rotation speed of the wafer in coating-film forming.

### DETAILED DESCRIPTION

In the following detailed description, reference is made to the accompanying drawings, which form a portion hereof. The illustrative embodiments described in the detailed description, drawings, and claims are not meant to be limiting. Other embodiments may be utilized, and other changes may be made, without departing from the spirit or scope of the subject matter presented here.

The present disclosure provides a substrate coating method and a substrate coating apparatus to achieve the uniformity of a coating-liquid film and the improvement of the yield by preventing the generation of bubbles during the application of a coating liquid.

Also, the present disclosure provides a substrate coating method and a substrate coating apparatus to improve the effective availability of the coating liquid by reducing the loss of a coating liquid.

According to the present disclosure, there is provided a substrate coating method to form a coating-liquid film by supplying a water-soluble coating liquid on a substrate. The substrate coating method includes forming a liquid pool of deionized water by rotating the substrate at low speed of a first rotation speed and supplying deionized water to the center of the substrate, mixing the water-soluble coating liquid with the deionized water by supplying the coating liquid to the center of the substrate in a state where the substrate is rotated at the first rotation speed, and forming the coating-liquid film by rotating the substrate at a second rotation speed higher than the first rotation speed.

In the substrate coating method, a supply amount of the coating liquid may be set by controlling a time ratio of mixing the coating liquid with the deionized water to forming the coating-liquid film.

In the substrate coating method, the coating liquid may include any coating liquid having at least water-solubility. Also, the coating liquid may include a liquid containing a surfactant.

According to the present disclosure, there is provided a substrate coating apparatus to form a coating-liquid film by supplying a water-soluble coating liquid on a substrate. The substrate coating apparatus includes a supporter to support the substrate, a rotation device to rotate the supporter around a vertical axis of the supporter, a coating-liquid nozzle to supply the coating liquid to the substrate, a deionized-water nozzle to supply deionized water to the substrate, a first nozzle moving device to move the coating-liquid nozzle to the center of the substrate, a second nozzle moving device to move the deionized-water nozzle to the center of the substrate, a first opening/closing valve provided in a coating-liquid supply conduit connecting the coating-liquid nozzle to a coating-liquid source, a second opening/closing valve provided in a deionized-water supply conduit connecting the deionized-water nozzle to a deionized-water source, and a controller to control rotational driving of the rotation device, driving of the first and second nozzle moving devices, and opening/closing of the first and second opening/closing valves. The controller controls the rotation device to rotate the substrate at low speed of a first rotation speed and controls the second nozzle moving device and the second opening/closing valve to supply the deionized water to the center of the substrate so that a liquid pool of the deionized water is formed on the substrate. The controller controls the first nozzle moving device and the first opening/closing valve to supply the coating liquid to the center of the substrate in a state where the substrate is rotated at the first rotation speed so that the water-soluble coating liquid is mixed with the deionized water. The controller controls the rotation device to rotate the substrate at a second rotation speed higher than the first rotation speed so that the coating-liquid film is formed on the substrate.

In the substrate coating apparatus, a supply amount of the coating liquid may be set by controlling a time ratio of mixing the coating liquid with the deionized water to forming the coating-liquid film.

In the substrate coating apparatus, the coating liquid may include any coating liquid having at least water-solubility. Also, the coating liquid may include a liquid containing a surfactant.

In the substrate coating method or apparatus, the time ratio of mixing the coating liquid with the deionized water to forming the coating-liquid film may be controlled by controlling the acceleration of the rotation speed. The time ratio of mixing the coating liquid with the deionized water to forming the coating-liquid film may range from 1:3 to 3:1. Also, the time ratio of mixing the coating liquid with the deionized water to forming the coating-liquid film may range from 1:1 to 3:1.

Also, in the substrate coating method or apparatus, the first rotation speed is a rotation speed at which the deionized water supplied (discharged) to the substrate can form a liquid pool (deionized-water puddle) on the substrate, and then the discharge impact of the water-soluble coating liquid supplied (discharged) to the substrate can be reduced. For example, the first rotation speed may range from 10 rpm to 50 rpm. If the first rotation speed is lower than 10 rpm, the liquid pool (deionized-water puddle) does not spread with a required size. If the first rotation speed is higher than 50 rpm, the liquid pool (deionized-water puddle) cannot maintain its circular state with a required size and excessively spread.

In the substrate coating method or apparatus, the second rotation speed is a rotation speed at which a coating-liquid film can be formed by diffusing the coating liquid supplied (discharged) on the substrate. In the substrate coating method or apparatus, the second rotation speed may range from 1500 rpm to 2500 rpm. If the second rotation speed is lower than 1500 rpm, the coatability of the coating liquid on the substrate is weakened. If the second rotation speed is higher than 2500 rpm, a mist of the coating liquid may be produced. Also, in the substrate coating method or apparatus, the second rotation speed may range from 2000 rpm to 4000 rpm. If the second rotation speed is lower than 2000 rpm, an unapplied area may occur on the substrate. If the second rotation speed is higher than 4000 rpm, a mist of the coating liquid may be produced and the re-adherence of the produced mist on the coating-liquid film may have a bad influence on the coatability.

In the substrate coating method or the substrate coating apparatus, a liquid pool of deionized water is formed by rotating the substrate at low speed of the first rotation speed and supplying the deionized water to the center of the substrate, and the water-soluble coating liquid is supplied to the center of the substrate and the coating liquid is mixed with the deionized water in a state where the substrate is rotated at the first rotation speed. Thus, during the supply of the coating liquid, the deionized water plays a role as a middle layer between the substrate and the coating liquid to reduce the impact in the supply (discharge) of the coating liquid. Then, the coating-liquid film is formed on the substrate by rotating the substrate at a second rotation speed higher than the first rotation speed.

Also, in the substrate coating method or apparatus, a liquid pool of deionized water may be formed by rotating the substrate at low speed of the first rotation speed and supplying the deionized water to the center of the substrate, and the water-soluble coating liquid is supplied to the center of the substrate and the coating liquid is mixed with the deionized water in a state where the substrate is rotated at the first rotation speed. Thus, during the supply of the coating liquid, the deionized water plays a role as a middle layer between the substrate and the coating liquid to reduce the impact in the supply (discharge) of the coating liquid. Then, the substrate is rotated at a second rotation speed higher than the first rotation speed. The time ratio of mixing the deionized water with the coating liquid to forming the coating-liquid film may be controlled within a range of 1:3 to 3:1 so that the discharged amount of the coating liquid can be set. Accordingly, it is possible to reduce the supply amount of the coating liquid and form a uniform coating-liquid film on the substrate.

Also, in the substrate coating method or apparatus, the impact in the supply of the coating liquid may be reduced and the concentration of a surfactant in the coating liquid may be reduced.

According to the present disclosure, the following advantages can be obtained through the above-described configuration.

According to the substrate coating method or apparatus, it is possible to reduce the occurrence of a coating defect (coating stain) through preventing the generation of bubbles in the applying of a coating liquid and to achieve the uniformity of a coating-liquid film and the improvement of the yield since deionized water plays a role as a middle layer between a substrate and the coating liquid during the supply of the coating liquid and reduces the impact in the supply (discharge) of the coating liquid.

According to the substrate coating method or apparatus, it is possible to improve the effective availability of the coating liquid, to reduce the occurrence of a coating defect (coating stain), and to improve the uniformity of the coating-liquid film.

According to the substrate coating method or apparatus, it is possible to achieve the uniformity of the coating-liquid film containing the surfactant and the improvement of the yield since the impact in the supply of the coating liquid reduces and the concentration of the surfactant in the coating liquid reduces during the supply of the coating liquid.

Hereinafter, embodiments of the present disclosure will be described in detail with reference to drawings.

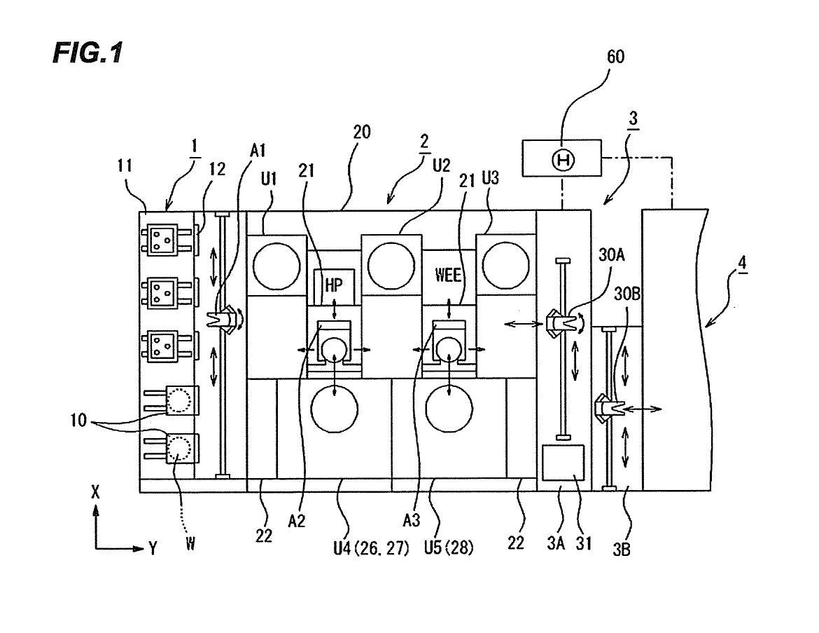

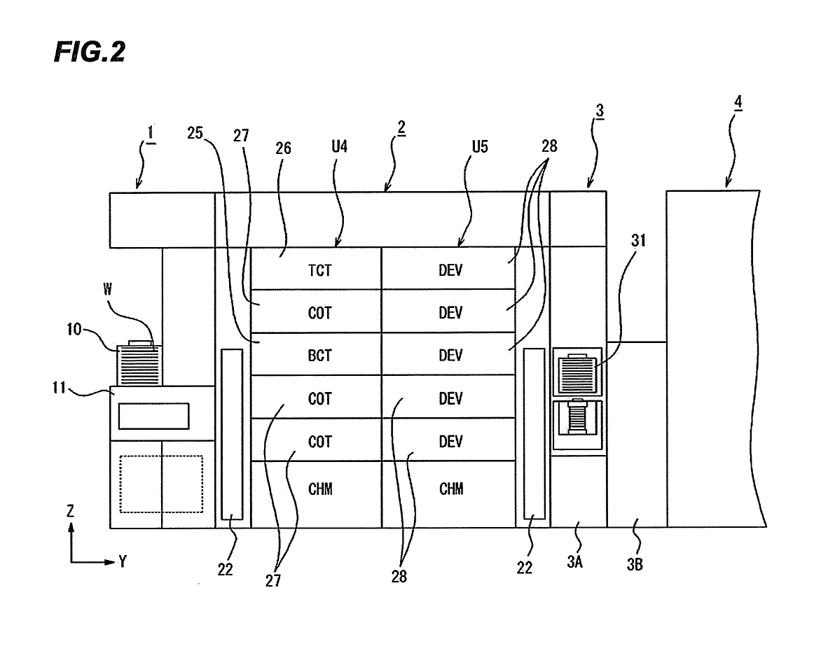

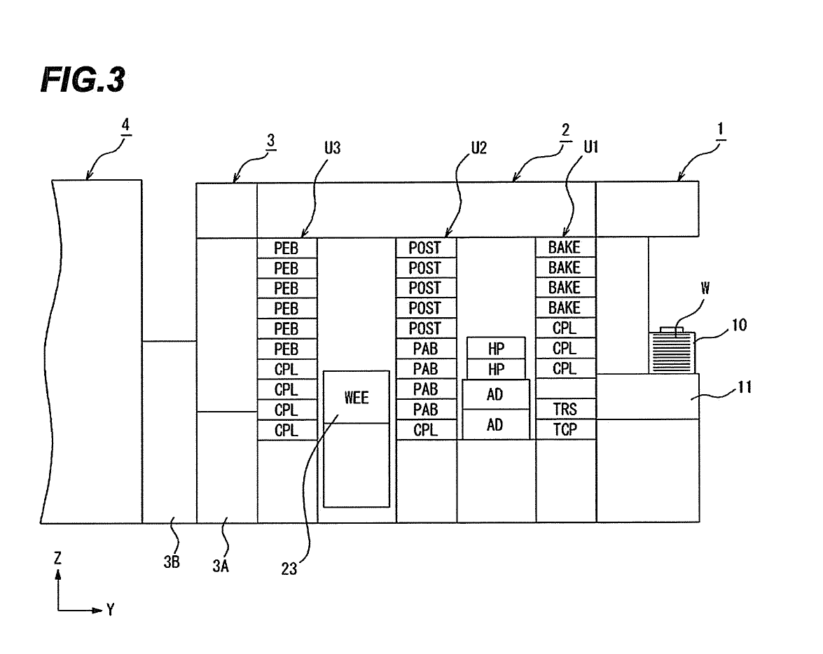

FIG. 1 is a schematic plan view illustrating an entire processing system including a substrate coating apparatus according to the present disclosure, a developing apparatus, and an exposure device connected to the substrate coating apparatus and developing apparatus. FIG. 2 is a schematic front view illustrating the processing system. FIG. 3 is a schematic rear view illustrating the processing system.

The processing system includes a carrier station 1 to load and unload carriers 10 hermetically receiving multiple semiconductor wafers W (hereinafter, referred to as a wafer W) as to-be-processed substrates, for example, twenty-five (25) semiconductor wafers, a processing part 2 to perform processes, such as application of resist and development, for wafer W taken out from carrier station 1, an exposure device 4 to perform an immersion exposure process on the surface of wafer W in a state where a light-transmissive immersion liquid layer is formed on the surface of wafer W, and an interface part 3 connected between processing part 2 and exposure device 4 to transfer wafer W.

Carrier station 1 includes an arranging part 11 to arrange multiple carriers 10 in a row, an open/closing part 12 provided at a front wall of arranging part 11, and a transferrer A1 to take out wafer W from carrier 10 via open/closing part 12.

The inside of carrier station 1 is connected to processing part 2 surrounded by a case 20. In processing part 2, main carrying units A2 and A3 are alternately provided between processing units U1, U2, and U3 and liquid-processing units U4 and U5. Processing units U1, U2, and U3 are multi-staged units of a heating/cooling system in order from the front line of processing part 2. Main carrying units A2 and A3 transfer wafer W between the units. Also, each main carrying unit A2 and A3 is provided within a space surrounded by a partition 21. Partition 21 includes surfaces of processing units U1, U2, and U3 disposed forward and backward from the perspective of carrier station 1, surfaces of liquid-processing units U4 and U5 of the right side, and rear surfaces of the left side. Also, temperature/humidity control units 22 are provided between carrier station 1 and processing part 2, and between processing part 2 and interface part 3. Temperature/humidity control unit 22 includes a temperature control device or a temperature/humidity control duct of a processing liquid used in each unit.

Processing units U1, U2, and U3 include various units to perform pre-processing and post-processing of the processing performed by liquid processing units U4 and U5, and the various units are layered in multiple, for example, ten (10) stages. Two adhesion units AD for hydrophobizing wafer W and two heating units HP for heating wafer W are layered in order from the bottom to the top at the backside of main carrying unit A2 as shown in FIG. 3. Adhesion unit AD may further include a unit to adjust the temperature of wafer W. A wafer edge exposure device WEE 23 is provided at the backside of main carrying unit A3. Wafer edge exposure device 23 selectively exposes only an edge of wafer W. Also, a heating unit may be disposed at the backside of main carrying unit A3 in the same manner at the backside of main carrying unit A2.

As shown in FIG. 3, processing unit U1 includes an oven-type processing unit to process wafer W placed on a arrangement board, a high-precision temperature control unit CPL to cool wafer W under the temperature control with the good precision, a transfer unit TRS to transfer wafer W from transferrer A1 to main carrying unit A2, and a temperature control unit TCP. The oven-type processing unit may be a high-temperature heating unit BAKE as a first heating unit to heat wafer W. High-temperature heating unit BAKE, high-precision temperature control unit CPL, transfer unit TRS, and temperature control unit TCP may be layered in ten stages in order from the top. Also, in processing unit U1 of the present embodiment, a spare space is provided at the third stage from the bottom. In processing unit U2, a post-baking unit POST as a fourth heating unit, a pre-baking unit PAB as a second heating unit to heat wafer W after the application of resist, and a high-precision temperature control unit CPL may be layered in ten stages in order from the top. Also, in processing unit U3, a post-exposure baking unit PEB as a third heating unit to heat wafer W after the exposure and a high-precision temperature control unit CPL may be layered in ten stages in order from the top.

Also, as shown in FIG. 2, each of liquid processing units U4 and U5 includes a bottom anti-reflection-film coating unit BCT 25 to apply an anti-reflective film, a top anti-reflection-film (protective film) coating unit TCT 26 provided with the substrate coating apparatus according to the present disclosure, a resist coating unit COT 27 to apply a resist, and a developing unit DEV 28 to develop wafer W through the supply of a developing liquid to wafer W. Bottom anti-reflection-film coating unit BCT 25, top anti-reflection-film coating unit TCT 26, resist coating unit COT 27, and developing unit DEV 28 are layered in multiple stages, for example, five stages above a chemical-liquid container CHM for a resist or a developing liquid.

As shown in FIG. 1, interface part 3 includes a first carrying chamber 3A and a second carrying chamber 3B. First carrying chamber 3A and second carrying chamber 3B are provided in order between processing part 2 and exposure device 4. Each carrying chamber 3A and 3B includes a first wafer carrying part 30A and a second wafer carrying part 30B. Each first and second wafer carrying part 30A and 30B has an arm moving up and down and rotating about a vertical axis.

Also, the timing and time period for carrying wafer W by first and second wafer carrying parts 30A and 30B are controlled by a controller 60. Controller 60 includes a central processing unit CPU of a control computer.

Also, first carrying chamber 3A includes a buffer cassette 31 at the right side of first wafer carrying part 30A from the perspective of carrier station 1. Buffer cassette 31 is vertically layered and temporarily receives multiple wafers W (for example, twenty-five wafers). Also, buffer cassette 31 may be disposed at the left side from the perspective of carrier station 1.

Hereinafter, the method of processing wafer W by using the substrate coating and developing apparatus will be described. In this description, a bottom anti-reflective coating film BARC is formed on the surface of wafer W, a resist layer is applied on the bottom anti-reflective coating film BARC, and a top anti-reflective coating film is layered on the surface of the resist layer. First, wafer W is taken out from carrier 10 receiving multiple wafers W by transferrer A1, and is transferred to main carrying unit A2 through transfer unit TRS constituting one stage in processing unit U1. Then, a bottom anti-reflective coating film BARC is formed on the surface of wafer W by bottom anti-reflection-film coating unit BCT 25 before performing the coating processing. Wafer W with the bottom anti-reflective coating film BARC is carried to the heating part of processing unit U1 by main carrying unit A2, and then is subjected to the pre-baking (BAKE).

Then, wafer W is loaded in resist coating unit COT 27 by main carrying unit A2, and a resist is applied in the form of a thin film on the entire surface of wafer W. Wafer W applied with the resist is carried to the heating part of processing unit U2 by main carrying unit A2, and then is subjected to the pre-baking process (PAB).

Then, wafer W is carried to top anti-reflection-film coating unit TCT 26 by main carrying unit A2, and a top anti-reflective coating film is formed on the surface of the resist layer. Wafer W with the top anti-reflective coating film is carried to the heating part of processing unit U2 by main carrying unit A2, and then is subjected to the pre-baking process (PAB).

Then, wafer W is unloaded from pre-baking unit PAB by main carrying unit A3, and is carried to exposure device 4 via main carrying unit A3 and first and second wafer carrying parts 30A and 30B. Next, wafer W is subjected to immersion exposure, in which the exposure is carried out in a state where an immersion liquid layer is formed between the surface of wafer W and an exposure lens (not shown).

Then, wafer W, which has been subjected to the exposure, is loaded in post-exposure baking unit PEB of processing unit U3 in processing part 2 via second wafer carrying part 30B and first wafer carrying part 30A. Herein, wafer W is subjected to the post-exposure baking (PEB) process. In the post-exposure baking (PEB) process, wafer W is heated to a temperature and an acid that is generated by an acid producing agent and included in a resist is diffused into the internal area of wafer W. Through the catalysis reaction of the acid, the resist component reacts chemically, thereby allowing the reacted area to become soluble in a developing liquid in the case of a positive resist.

Wafer W, which has been subjected to the PEB process, is loaded in developing unit DEV 28 by main carrying unit A3, and a developing-liquid nozzle provided within developing unit DEV 28 supplies a developing liquid to the surface of wafer W to perform a development process. Through the development process, a portion of the resist layer soluble in the developing liquid on the surface of wafer W is dissolved, thereby forming a resist pattern. Also, a rinsing liquid, such as deionized water, is supplied to wafer W to perform a rinsing process, and then spin drying is performed to shake off the rinsing liquid. Then, wafer W is unloaded from developing unit DEV 28 by main carrying unit A3, and is loaded in post-baking unit POST of processing unit U2 to perform a heating process. Next, wafer W is returned to its original position (that is, carrier 10) in arranging part 11 via main carrying unit A2 and transferrer A1, and a series of coating and developing processes are completed.

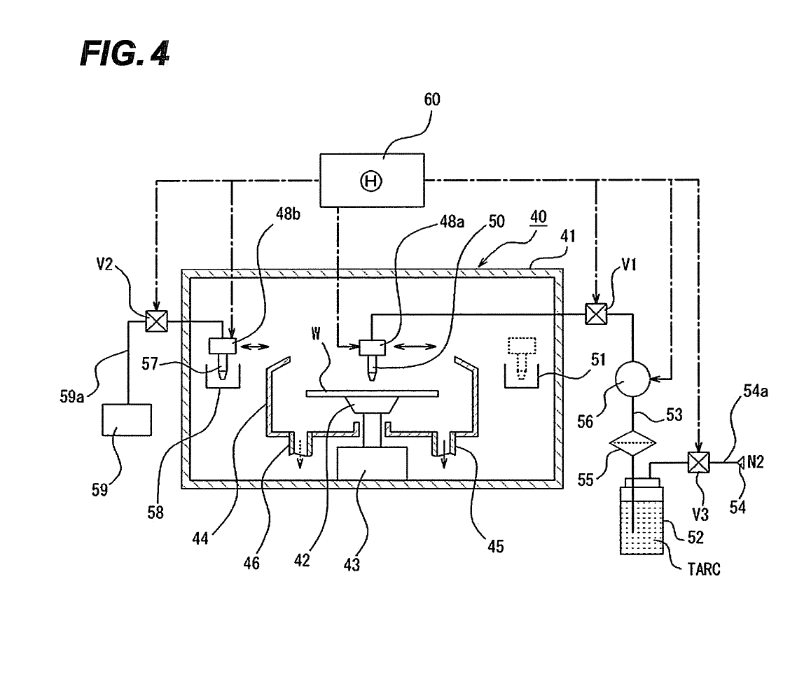

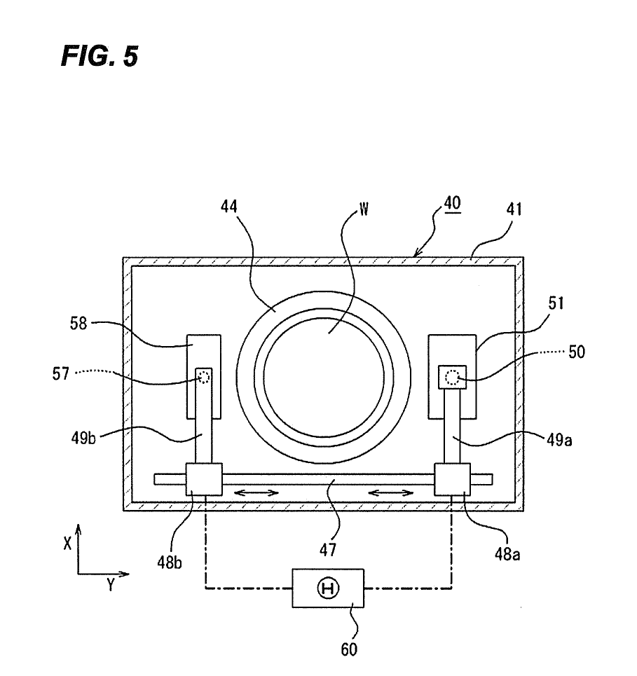

Hereinafter, the substrate coating apparatus according to the present disclosure will be described with reference to FIGS. 4 and 5.

FIG. 4 is a schematic longitudinal-sectional view illustrating one example of a substrate coating apparatus according to the present disclosure, and FIG. 5 is a schematic cross-sectional view illustrating the substrate coating apparatus. In the present embodiment, an anti-reflective film liquid material (a TARC chemical liquid) is used as a coating liquid. The anti-reflective film liquid material contains a surfactant that is applied on wafer W formed with a resist film in order to form an anti-reflective film for inhibiting the reflection of light during an exposure process. The anti-reflective film liquid material as the coating liquid may include a water soluble resin and a low molecular weight organic compound, such as carboxylic acid or sulfonic acid.

As shown in FIG. 4, a substrate coating apparatus 40 includes a processing container 41. A spin chuck 42 is provided as a supporter to support and rotate wafer W at the middle portion within processing container 41. Spin chuck 42 has a horizontal upper surface, and the upper surface may have a suction hole (not shown) to attract wafer W. Wafer W can be adsorbed and supported on spin chuck 42 by the attraction of the suction hole.

Spin chuck 42 includes a chuck driving device 43 provided with a rotation device, such as a motor. Chuck driving device 43 is electrically connected to controller 60 including a central processing unit (CPU). Chuck driving device 43 can rotate at a speed based on the control signal from controller 60. Also, chuck driving device 43 includes an elevating driver, such as a cylinder, and spin chuck 42 can move up and down.

A cup 44 is provided around spin chuck 42. Cup 44 receives and collects a liquid scattered or fallen from wafer W. The bottom surface of cup 44 is connected with a drain conduit 45 to discharge the collected liquid and an exhaust conduit 46 to exhaust the atmosphere within cup 44.

As shown in FIG. 5, a guide rail 47 extends in a Y direction (left/right direction in FIG. 5) at −X direction side (the lower side in FIG. 5) of cup 44. Guide rail 47 may be formed from the outside of −Y direction side (the left side in FIG. 5) of cup 44 to the outside of +Y direction side (the right side in FIG. 5). A first nozzle driving part 48a and a second nozzle driving part 48b as first and second nozzle moving units are movably mounted at guide rail 47. First and second nozzle driving unit 48a and 48b are electrically connected to controller 60, and can move along guide rail 47 according to the control signal from controller 60.

A first arm 49a is attached to first nozzle driving part 48a in the X direction. A coating-liquid nozzle 50 is supported on first arm 49a to supply a coating liquid as shown in FIGS. 4 and 5. Coating-liquid nozzle 50 has a nozzle diameter, for example, a diameter of 0.8 mm, allowing a small amount of coating liquid to be discharged. First arm 49a can be moved on guide rail 47 by first nozzle driving part 48a. Accordingly, coating-liquid nozzle 50 can move from a waiting part 51 provided at the outside of +Y direction side of cup 44 to the position above the center of wafer W within cup 44, and also can move in a diametrical direction of wafer W above the surface of waver W. Also, first arm 49a can be moved up and down by first nozzle driving part 48a, and the height of coating-liquid nozzle 50 can be adjusted.

As shown in FIG. 4, coating-liquid nozzle 50 is connected to a coating-liquid supply conduit 53 connected with a coating-liquid source 52. Coating-liquid source 52 includes a bottle storing a coating liquid, and the coating liquid is supplied to coating-liquid nozzle 50 by pressurization of gas (N₂ gas) supplied from a gas source, such as a N₂ gas source 54. In coating-liquid supply conduit 53, a filter 55, a pump 56, and a first opening/closing valve V1 controlling the flow rate are provided in order from coating-liquid source 52. Also, an opening/closing valve V3 is provided in an N₂ gas supply conduit 54a connecting coating-liquid source 52 to N₂ gas source 54.

A second arm 48b is attached to second nozzle driving part 48b in the X direction. A deionized-water nozzle 57 is supported on second arm 49b. Deionized-water nozzle 57 supplies a solvent of a coating liquid, such as deionized water. Second arm 49b can be moved on guide rail 47 by second nozzle driving part 48b as shown in FIG. 5, and can move deionized-water nozzle 57 from a waiting area 58 provided at the outside of −Y direction side of cup 44 to the position above the center of wafer W within cup 44. Also, second arm 49b can be moved up and down by second nozzle driving part 48b, and can adjust the height of deionized-water nozzle 57.

As shown in FIG. 4, deionized-water nozzle 57 is connected with a deionized-water supply conduit 59a connected with a deionized-water source 59. Deionized water is stored within deionized-water source 59. Deionized-water supply conduit 59a is provided with a second opening/closing valve V2 controlling the flow rate.

Each of first and second opening/closing valves V1 and V2 and opening/closing valve V3 of N₂ gas supply conduit 54a is electrically connected to controller 60, and is opened and closed according to the control signal from controller 60.

Also, in the above-described configuration, coating-liquid nozzle 50 supplying a coating liquid and deionized-water nozzle 57 supplying deionized water are supported by respective arms. However, these nozzles may be supported by the same arm, and the timing of movement and supply of coating-liquid nozzle 50 and deionized-water nozzle 57 may be controlled by the control for the movement of the arm.

Controller 60 controls the above-described movements of the driving system, such as the rotation and up/down movement of spin chuck 42, the movement of coating-liquid nozzle 50 by first nozzle driving part 48a, the supply of a coating liquid of coating-liquid nozzle 50 by first opening/closing valve V1, the movement of deionized-water nozzle 57 by second nozzle driving part 48b, and the supply of deionized water of deionized-water nozzle 57 by second opening/closing valve V2. Controller 60 may include a computer provided with a CPU or a memory, and may perform the application of resist in substrate coating apparatus 40 through the execution of a program stored in the memory. Also, various programs for the execution of the application of resist in substrate coating apparatus 40 may be stored in a storage medium H, such as a computer readable hard disc (HD), a flexible disc (FD), a compact disc (CD), a magneto-optical disc (MD), and a memory card. A program is installed from storage medium H to controller 60 for use.

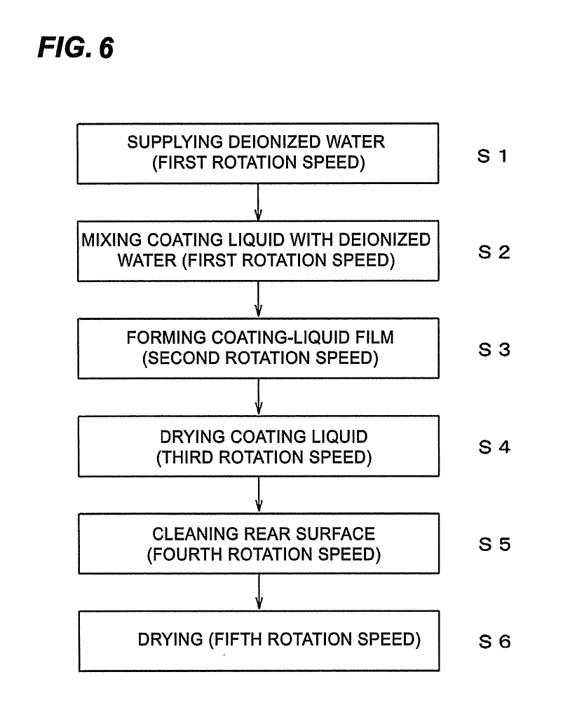

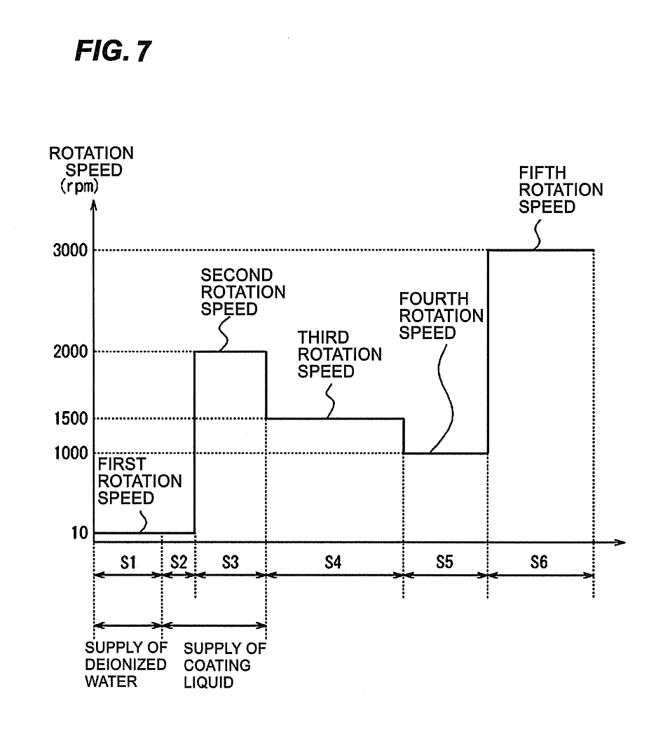

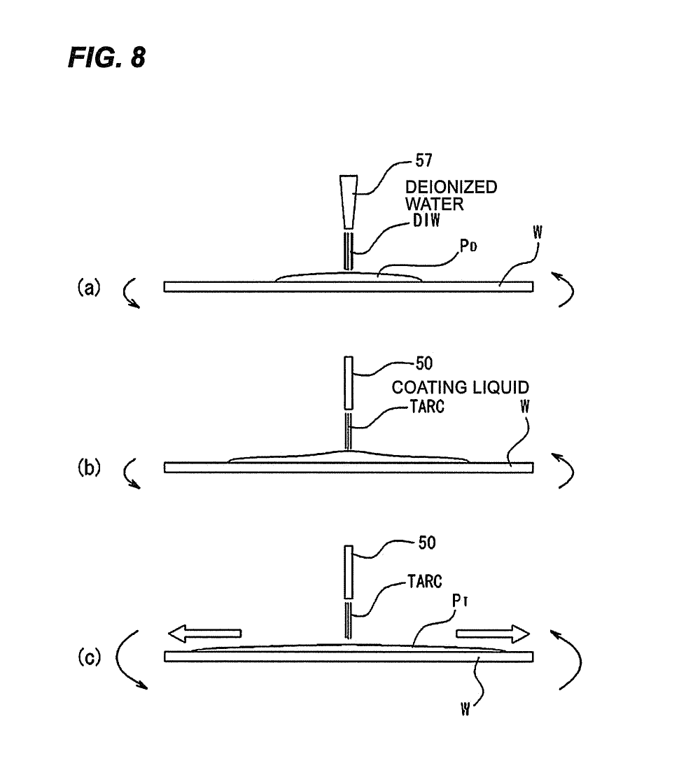

Hereinafter, a substrate coating method by substrate coating apparatus 40 with the above-described configuration will be described. FIG. 6 is a flowchart illustrating main coating processing processes in substrate coating apparatus 40. FIG. 7 is a graph illustrating a rotation speed of wafer W and a supply timing of a coating liquid and deionized water in each coating processing process, and FIG. 8 is a schematic cross-sectional view illustrating the state of a liquid film on wafer W in each coating processing process. Also, in FIG. 7, the length of time of each process does not correspond to the actual length of time since the length of time of each process is illustrated for easy understanding of the technology.

First, wafer W loaded in substrate coating apparatus 40 is adsorbed and supported on spin chuck 42. Then, deionized-water nozzle 57 in waiting area 58 is moved to the position above the center of wafer W by second arm 49b. Then, as shown in FIG. 4, wafer W is rotated at a first rotation speed ranging from 10 rpm to 50 rpm (10 rpm in the present embodiment) by spin chuck 42 through the control of chuck driving device 43. While wafer W is rotated as above, deionized water (DIW) is supplied from deionized-water nozzle 57 to the center of wafer W as shown in FIG. 8 (a) (see step S1 of FIGS. 6 and 7). When wafer W is rotated at low speed of the first rotation speed as above, deionized water (DIW) supplied to wafer W is hardly diffused on wafer W, and forms a liquid pool of deionized water (a deionized-water puddle (PD)), for example, with approximately 0.5 mm to 4.0 mm. This step S1 may be performed for 4 seconds.

When the supply of deionized water is stopped, deionized-water nozzle 57 moves from the position above the center of wafer W to the outside of wafer W, and coating-liquid nozzle 50 in waiting part 51 is moved to the position above the center of wafer W by first arm 49a.

Then, at a first rotation speed, for example, 10 rpm, a coating liquid (a TARC chemical liquid) (TARC) is supplied (discharged) as shown in FIG. 8 (b) from coating-liquid nozzle 50 to the center of wafer W (see step S2 in FIGS. 6 and 7). Since a coating liquid (a TARC chemical liquid) is supplied (discharged) on deionized water, that is, the deionized-water puddle (PD) during rotating wafer W at low speed of the first rotation speed, the deionized-water puddle (PD) can reduce the discharge impact of the coating liquid (TARC) and reduce the concentration of a surfactant contained in the coating liquid (TARC). Accordingly, it is possible to inhibit the generation of bubbles during the supply (discharge) of the coating liquid (TARC). This step S2 may be performed for 0.5 seconds.

When the coating liquid (TARC) is supplied (discharged) on the deionized-water puddle (PD) as described above and a mixed layer of the coating liquid and deionized water remained in the lower layer of the coating liquid (TARC) is formed, the rotation of wafer W is accelerated to a second rotation speed, for example, 1500 rpm to 2500 rpm, (2000 rpm in the present embodiment) as shown in FIG. 7. During this step, as shown in FIG. 8 (c), the coating liquid (TARC) is continuously supplied from coating-liquid nozzle 50. When wafer W is rotated at high speed of the second rotation speed in this manner, the mixed layer (P_{T}) is diffused on wafer W and the coating liquid (TARC) is drawn by the mixed layer (P_{T}) to diffuse on wafer W and form a coating-liquid film (S3 in FIGS. 6 and 7). Since the mixed layer (P_{T}) has a lower contact angle and a higher wettability for a resist film than deionized water, the coating liquid (TARC) can be smoothly and uniformly diffused on the entire surface of wafer W. Bubbles are generated in only infinitesimal amount, if any, and are blocked by deionized water. Thus, the bubbles are hardly attached on wafer W and do not cause watermark. This step S3 is performed for 1.5 seconds.

When the coating-liquid film is formed by the diffusion of the coating liquid (TARC) on the entire surface of wafer W, the rotation of wafer W is decelerated to a third rotation speed, for example, 1500 rpm, as shown in FIG. 7. Then, during the rotation of wafer W at the third rotation speed, the coating liquid (TARC) on wafer W is subject to a centripetal force and the coating-liquid film on wafer W is dried (adjusted) (step S4 in FIGS. 6 and 7). This step S4 is performed for 15 seconds.

When the film thickness of the coating liquid (TARC) on wafer W is adjusted, the rotation of wafer W is decelerated to a fourth rotation speed, for example, 1000 rpm, as shown in FIG. 7. Then, during the rotation of wafer W at the fourth rotation speed, a rinsing liquid, such as deionized water, is supplied (discharged) from a rinse nozzle (not shown) to the circumferential periphery of the rear surface of wafer W to clean the rear surface of wafer W (step S5 in FIGS. 6 and 7). This step S5 is performed for 5 seconds. Then, the rotation of wafer W is accelerated to a fifth rotation speed, for example, of 3000 rpm, and the coating liquid (TARC) diffused over the entire surface of wafer W is dried and a coating film is formed (step S6 in FIGS. 6 and 7). This step S6 is performed for 10 seconds.

According to the embodiment, wafer W is rotated at low speed of the first rotation speed, the deionized-water puddle (PD) is formed on wafer W, and the coating liquid (TARC) is supplied (discharged) during the rotation of wafer W at low speed of a first rotation speed. Thus, it is possible to reduce the discharge impact of the coating liquid (TARC) by the deionized-water puddle (PD). Also, since deionized water and the coating liquid (TARC) are mixed with each other during the rotation of wafer W at low speed of the first rotation speed, it is possible to partially reduce the concentration of a surfactant contained in the coating liquid (TARC). Accordingly, it is possible to inhibit the generation of bubbles during the supply (discharge) of the coating liquid (TARC), to reduce the occurrence of a coating defect (coating stain), and to improve the uniformity and yield of the coating-liquid film.

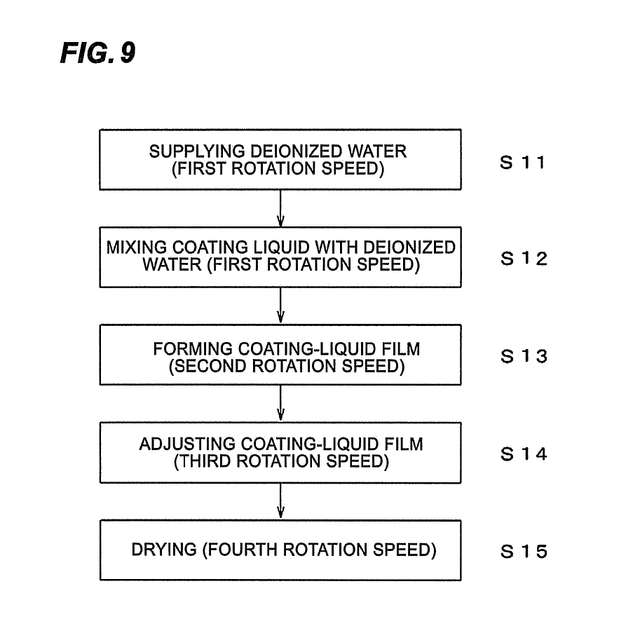

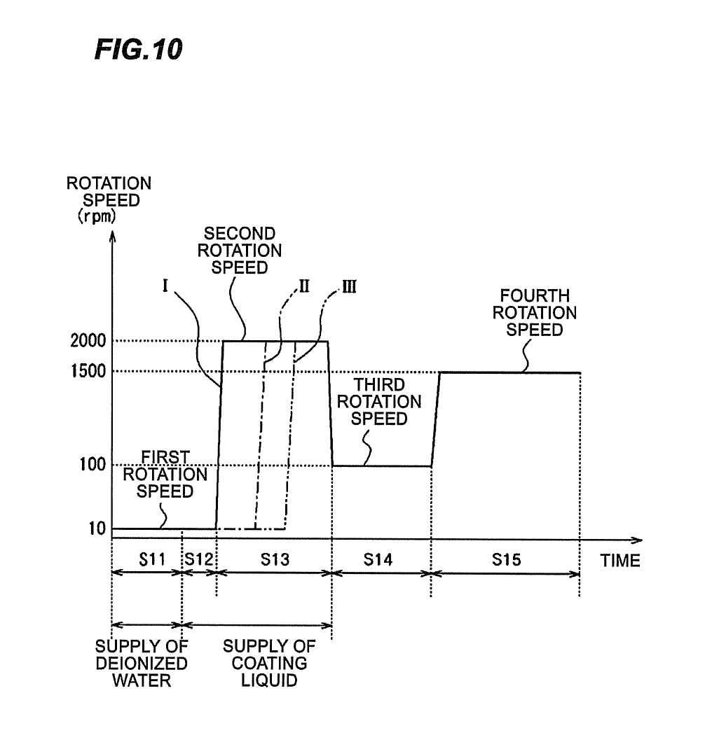

Hereinafter, another coating processing by substrate coating apparatus 40 with the above-described configuration will be described. FIG. 9 is another flowchart illustrating main coating processes in substrate coating apparatus 40. FIG. 10 is another graph illustrating a rotation speed of wafer W and a supply timing of the coating liquid and deionized water in each coating process. Also, in FIG. 10, the length of time of the process does not correspond to the actual length of time since the length of time of the process is illustrated for easy understanding of the technology.

First, wafer W loaded in substrate coating apparatus 40 is adsorbed and supported on spin chuck 42. Then, deionized-water nozzle 57 in waiting area 58 is moved to the position above the center of wafer W by second arm 49b. Then, as shown in FIG. 4, wafer W is rotated at a first rotation speed, for example, 10 rpm to 50 rpm, (10 rpm in the present embodiment) by spin chuck 42 through the control of chuck driving device 43. While wafer W is rotated in this manner, deionized water (DIW) is supplied from deionized-water nozzle 57 to the center of wafer W as shown in FIG. 8 (a) (see step S11 of FIGS. 9 and 10). When wafer W is rotated at low speed of the first rotation speed as above, deionized water supplied to wafer W is hardly diffused on wafer W and forms a liquid pool of deionized water (a deionized-water puddle (PD)), for example, with approximately 0.5 mm to 4.0 mm. This step S11 may be performed for 4 seconds.

When the supply of deionized water is stopped, deionized-water nozzle 57 is moved from the position above the center of wafer W to the outside of wafer W and coating-liquid nozzle 50 in waiting part 51 is moved to the position above the center of wafer W by first arm 49a.

Then, at a first rotation speed, for example, 10 rpm, a coating liquid (a TARC chemical liquid) is supplied (discharged) as shown in FIG. 8 (b) from coating-liquid nozzle 50 to the center of wafer W (step S12 in FIGS. 9 and 10). Since a coating liquid (TARC) is supplied (discharged) on deionized water, that is, the deionized-water puddle (PD), during the rotation of wafer W at low speed of the first rotation speed, the deionized-water puddle (PD) can reduce the discharge impact of the coating liquid (TARC) and reduce the concentration of a surfactant contained in the coating liquid (TARC). Accordingly, it is possible to inhibit the generation of bubbles during the supply (discharge) of the coating liquid (TARC). Also, this step S12 may be performed for 0.5 seconds to 1.5 seconds, (0.5 seconds in the present embodiment).

When the coating liquid (TARC) is supplied (discharged) on the deionized-water puddle (PD) as described above and a mixed layer of the coating liquid (TARC) and deionized water remained in the lower layer of the coating liquid (TARC) is formed, the rotation of wafer W is accelerated to a second rotation speed, for example, 2000 rpm to 4000 rpm, (2000 rpm in the present embodiment) as shown in FIG. 10. During this step, as shown in FIG. 8 (c), the coating liquid (TARC) is continuously supplied from coating-liquid nozzle 50. When wafer W is rotated at high speed of the second rotation speed as above, the mixed layer (P_{T}) is diffused over wafer W, and the coating liquid (TARC) is drawn by the mixed layer (P_{T}) and diffused over wafer W to form a coating-liquid film (step S13 in FIGS. 9 and 10). Since the mixed layer (P_{T}) has a lower contact angle and a higher wettability for a resist film than deionized water, the coating liquid (TARC) can be smoothly and uniformly diffused on the entire surface of wafer W. Bubbles are generated in only infinitesimal amount, if any, and are blocked by deionized water. Thus, the bubbles are hardly attached on wafer W and do not cause watermark. This step S13 may be performed for 0.5 seconds to 1.5 seconds (1.5 seconds in the present embodiment).

When the coating-liquid film is formed by the diffusion of the coating liquid (TARC) on the entire surface of wafer W, the rotation of wafer W is decelerated to a third rotation speed, for example, 100 rpm, as shown in FIG. 10. Then, during the rotation of wafer W at the third rotation speed, the coating liquid (TARC) on wafer W is subject to a centripetal force and the coating-liquid film on wafer W is dried (adjusted) (step S14 in FIGS. 9 and 10). Also, this step S14 may be performed, for example, 1 second.

When the film thickness of the coating liquid (TARC) on wafer W is adjusted, the rotation of wafer W is accelerated to a fourth rotation speed, for example, 1000 rpm to 2000 rpm, (1500 rpm in the present embodiment) as shown in FIG. 10. Through this process, the coating liquid (TARC) diffused over the entire surface of wafer W is dried and a coating film is formed (step S15 in FIGS. 9 and 10). This step S15 may be performed for 10 seconds.

Also, in the above-described embodiment, step S12 for mixing deionized water with the coating liquid (TARC) is performed for 0.5 seconds, and step S13 for forming the coating-liquid film is performed for 1.5 seconds (see I in FIG. 10). However, as shown in II in FIG. 10, steps S12 and S13 may be performed for 1.0 second and 1.0 second, respectively, or as shown in III in FIG. 10, steps S12 and S13 may be performed for 1.5 seconds and 0.5 seconds, respectively. In this manner, the time ratio of step S12 for mixing deionized water (DIW) with the coating liquid (TARC) to step S13 for forming the coating-liquid film is controlled within a range of 1:3 to 3:1 (that is, S12:S13=1:3 to 3:1), and thus the discharge amount of the coating liquid (TARC) can be set within a range allowing the thickness of the coating-liquid film to be uniformly formed.

According to the above-described embodiment, wafer W is rotated at low speed of the first rotation speed, a deionized-water puddle (PD) is formed on wafer W, and a coating liquid (TARC) is supplied (discharged) during the rotation of the wafer at the first rotation speed. Thus, it is possible to reduce the discharge impact of the coating liquid (TARC) by the deionized-water puddle (PD). Also, since deionized water (DIW) and the coating liquid (TARC) are mixed with each other during the rotation of wafer W at low speed of the first rotation speed, it is possible to partially reduce the concentration of a surfactant contained in the coating liquid (TARC). Accordingly, it is possible to inhibit the generation of bubbles during the supply (discharge) of the coating liquid (TARC) and reduce the occurrence of a coating defect (coating stain). This allows the coating-liquid film to uniformly spread in step S12 for mixing deionized water (DIW) with the coating liquid (TARC).

Also, according to the above-described embodiment, in a state where the coating-liquid film uniformly spreads by step S12 for mixing deionized water (DIW) with the coating liquid (TARC), wafer W is rotated at high speed of a second rotation speed during the supply (discharge) of the coating liquid (TARC). Thus, a mixed layer (P_{T}) is diffused over wafer W and the coating liquid (TARC) is drawn by the mixed layer (P_{T}) and diffused over wafer W to form a coating-liquid film. Accordingly, it is possible to achieve the uniformity of the coating film by a small amount of coating liquid (TARC).

Although the embodiments of the present disclosure have been described with reference to drawings, the present disclosure is not limited thereto and various aspects may be used. For example, although a coating liquid forming an anti-reflective film is used as a water-soluble coating liquid in the above-described embodiments, the present disclosure may be applied to a resist pattern dimension reducing agent (RELACS agent) in the technology of RELACS (Resolution Enhancement Lithography Assisted by Chemical Shrink). Also, although the coating processing is performed on a wafer in the above-described embodiments, the present disclosure may be applied to coating processing using other substrates, such as an FPD substrate and a mask/reticle for a photomask, besides the wafer.

Also, although an exposure device is for an immersion exposure process in the above-described embodiments, the substrate coating apparatus (method) according to the present disclosure may be applied to other substrate coating and developing apparatus employing other exposure techniques besides the immersion exposure process.

### Embodiment

Hereinafter, in the substrate coating method in FIGS. 9 and 10, the test for the rotation (acceleration) control of wafer W and the usage amount of a coating liquid (TARC) will be described.

First, a wafer that has been subjected to the adhesion processing (ADH) is prepared as a test sample in which coatability of a coating liquid (TARC) is low. Then, in the case where a wafer is rotated at 10 rpm in step S12 for mixing deionized water (DIW) with the coating liquid (TARC) and is rotated at 2000 rpm in step S13 for forming a coating-liquid film, the time ratio of step S12 for mixing deionized water (DIW) with the coating liquid (TARC) to step S13 for forming the coating-liquid film is controlled to 0.5 (s):1.5 (s), 1.0 (s):1.0 (s), and 1.5 (s):0.5 (s), as noted in Tables 1, 2, and 3 based on a minimum discharge amount of the coating liquid (TARC) ensuring the formability (coatability) of the thickness of the coating-liquid film. In other words, the time ratio of step S12 for mixing deionized water (DIW) with the coating liquid (TARC) to step S13 for forming the coating-liquid film is set to 1:3, 1:1, and 3:1.

TABLE 1

| step | time (second) | rotation speed (rpm) | discharge |
|---|---|---|---|
| 11 | 4.0 | 10 | DIW |
| 12 | 0.5 | 10 | TARC |
| 13 | 1.5 | 2000 | TARC |
| 14 | 1.0 | 100 | — |
| 15 | 10.0 | 1500 | — |

TABLE 2

| | | revolution per minute | |
|---|---|---|---|
| step | time (second) | (rpm) | discharge |
| 11 | 4.0 | 10 | DIW |
| 12 | 1.0 | 10 | TARC |
| 13 | 1.0 | 2000 | TARC |
| 14 | 1.0 | 100 | — |
| 15 | 10.0 | 1500 | — |

TABLE 3

| | | revolution per minute | |
|---|---|---|---|
| step | time (second) | (rpm) | discharge |
| 11 | 4.0 | 10 | DIW |
| 12 | 1.5 | 10 | TARC |
| 13 | 0.5 | 2000 | TARC |
| 14 | 1.0 | 100 | — |
| 15 | 10.0 | 1500 | — |

When the time ratio of step S12 to step S13 was set to 0.5 (s):1.5 (s) (Embodiment 1), 1.0 (s):1.0 (s) (Embodiment 2), and 1.5 (s):0.5 (s) (Embodiment 3), the coatability of the coating film and the discharge amount of the coating liquid (TARC) were measured. The results noted in Table 4 were obtained.

TABLE 4

| | discharged amount (ml) | | | | | | | | | | | | | | | |
|---|---|---|---|---|---|---|---|---|---|---|---|---|---|---|---|---|
| | 0.3 | 0.4 | 0.5 | 0.6 | 0.7 | 0.8 | 0.9 | . . . | 1.5 | 1.6 | 1.7 | 1.8 | 1.9 | 2.0 | 2.1 | 2.2 |
| Embodiment 1 | X | X | X | X | X | X | X | X | X | X | X | ◯ | ◯ | ◯ | ◯ | ◯ |
| Embodiment 2 | X | X | X | ◯ | ◯ | ◯ | ◯ | ◯ | ◯ | ◯ | ◯ | ◯ | ◯ | ◯ | ◯ | ◯ |
| Embodiment 3 | X | ◯ | ◯ | ◯ | ◯ | ◯ | ◯ | ◯ | ◯ | ◯ | ◯ | ◯ | ◯ | ◯ | ◯ | ◯ |

◯: good in uniformity (coatability) of a coating-liquid film
X: poor in uniformity (coatability) of a coating-liquid film

According to the test results, the formability (coatability) of the coating-liquid film thickness was ensured with a coating-liquid (TARC) discharge amount of 1.8 ml in Embodiment 1, the formability (coatability) of the coating-liquid film thickness was ensured with a coating-liquid (TARC) discharge amount of 0.6 ml in Embodiment 2, and the formability (coatability) of the coating-liquid film thickness was ensured with a coating-liquid (TARC) discharge amount of 0.4 ml in Embodiment 3. Accordingly, the discharge amount in Embodiment 1 was significantly small, compared to that (5.0 ml to 6.0 ml) of a conventional method in which a coating liquid (TARC) is supplied (discharged) on a wafer by low speed rotation and spreads by high speed rotation. Also, although the uniformity (coatability) of the coating-liquid film was poor at a discharge amount of 1.7 ml or less in Embodiment 1, the uniformity (coatability) of the coating-liquid film was good at a discharge amount of at least 0.6 ml in Embodiment 2. Also, in Embodiment 3, the uniformity (coatability) of the coating-liquid film was good at a discharge amount of at least 0.4 ml, and it was possible to significantly reduce the discharge amount in comparison to that in Embodiment 1.

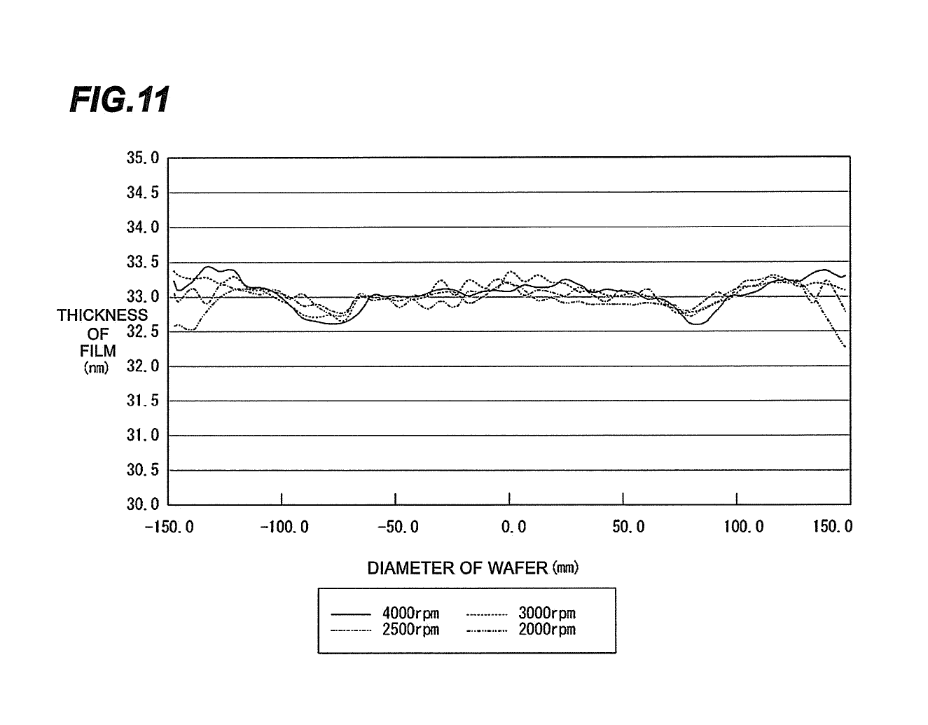

In the above-described tests, the wafer was rotated at 2000 rpm during step S13 for forming a coating-liquid film. However, the distribution of the film thickness was tested when a coating liquid (a discharge amount of 0.5 ml) was supplied (discharged) to a wafer surface at wafer rotation speed of 2000 rpm, 2500 rpm, 3000 rpm, and 4000 rpm. The film thickness was hardly changed at the wafer rotation speed of 2000 rpm, 2500 rpm, 3000 rpm, and 4000 rpm as shown in FIG. 11. Accordingly, rotation speed of 2000 rpm to 4000 rpm may be selected as the wafer rotation speed in step S13 for forming the coating-liquid film.

Also, when a wafer rotation speed is 1500 rpm, the film thickness is very similar to that at 2000 rpm to 4000 rpm. However, in this case, an uncoated area is produced and a coating limit is reduced by approximately 0.1 ml in comparison to that of 2000 rpm to 4000 rpm. Also, when a wafer rotation speed is higher than 4000 rpm, a mist of a coating liquid is produced. Re-adherence of the mist on the coating-liquid film deteriorates the coatability.

The above-described tests only explains a case where a wafer rotation speed was 10 rpm during step S12 for mixing deionized water (DIW) with the coating liquid (TARC). However, when the wafer rotation speed is from 10 rpm to 50 rpm, a liquid pool (a deionized-water puddle) can spread with a required size. Thus, it is assumed that as long as the wafer rotation speed ranges from 10 rpm to 50 rpm in step S12 for mixing deionized water (DIW) with the coating liquid (TARC), the same result as those of the tests can be obtained.

Also, when wafer rotation speed is lower than 10 rpm, the bank of the outer circumferential portion forming a liquid pool (a deionized-water puddle) is partially destroyed, deionized water from the destroyed portion extends in a whisker (branch) shape, and it is impossible to maintain a circular shape with a required size. Accordingly, the wafer rotation speed of 10 rpm to 50 rpm may be proper in step S12 for mixing deionized water (DIW) with the coating liquid (TARC).

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A substrate coating method to form a coating-liquid film by supplying a water-soluble coating liquid on a substrate, the substrate coating method comprising:
forming a liquid pool of deionized water by rotating the substrate at low speed of a first rotation speed and supplying deionized water to the center of the substrate;
mixing the water-soluble coating liquid with the deionized water by supplying the coating liquid to the center of the substrate in a state where the substrate is rotated at the first rotation speed; and
forming the coating-liquid film by rotating the substrate at a second rotation speed higher than the first rotation speed.

2. The substrate coating method of claim 1, wherein the first rotation speed ranges from 10 rpm to 50 rpm.

3. A substrate coating method to form a coating-liquid film by supplying a water-soluble coating liquid on a substrate, the substrate coating method comprising:
forming a liquid pool of the deionized water by rotating the substrate at low speed of a first rotation speed and supplying deionized water to the center of the substrate;
mixing the water-soluble coating liquid with the deionized water by supplying the coating liquid to the center of the substrate in a state where the substrate is rotated at the first rotation speed; and
forming the coating-liquid film by rotating the substrate at a second rotation speed higher than the first rotation speed,
wherein a supply amount of the coating liquid is set by controlling a time ratio of mixing the coating liquid with the deionized water to forming the coating-liquid film.

4. The substrate coating method of claim 3, wherein the time ratio of mixing the coating liquid with the deionized water to forming the coating-liquid film ranges from 1:3 to 3:1.

5. The substrate coating method of claim 3, wherein the first rotation speed ranges from 10 rpm to 50 rpm and the second rotation speed ranges from 2000 rpm to 4000 rpm.

6. The substrate coating method of claim 1, wherein the coating liquid comprises a surfactant.

7. A substrate coating apparatus to form a coating-liquid film by supplying a water-soluble coating liquid on a substrate, the substrate coating apparatus comprising:
a supporter to support the substrate;
a rotation device to rotate the supporter around a vertical axis of the supporter;
a coating-liquid nozzle to supply the coating liquid to the substrate;
a deionized-water nozzle to supply deionized water to the substrate;
a first nozzle moving device to move the coating-liquid nozzle to the center of the substrate;
a second nozzle moving device to move the deionized-water nozzle to the center of the substrate;
a first opening/closing valve provided in a coating-liquid supply conduit connecting the coating-liquid nozzle to a coating-liquid source;
a second opening/closing valve provided in a deionized-water supply conduit connecting the deionized-water nozzle to a deionized-water source; and
a controller to control rotational driving of the rotation device, driving of the first and second nozzle moving devices, and opening/closing of the first and second opening/closing valves,
wherein the controller controls the rotation device to rotate the substrate at low speed of a first rotation speed and controls the second nozzle moving device and the second opening/closing valve to supply the deionized water to the center of the substrate so that a liquid pool of the deionized water is formed on the substrate,
the controller controls the first nozzle moving device and the first opening/closing valve to supply the coating liquid to the center of the substrate in a state where the substrate is rotated at the first rotation speed so that the water-soluble coating liquid is mixed with the deionized water, and
the controller controls the rotation device to rotate the substrate at a second rotation speed higher than the first rotation speed, so that the coating-liquid film is formed on the substrate.

8. The substrate coating apparatus of claim 7, wherein the first rotation speed ranges from 10 rpm to 50 rpm.

9. A substrate coating apparatus to form a coating-liquid film by supplying a water-soluble coating liquid on a substrate, the substrate coating apparatus comprising:
a supporter to support the substrate;
a rotation device to rotate the supporter around a vertical axis of the supporter;
a coating-liquid nozzle to supply the coating liquid to the substrate;
a deionized-water nozzle to supply deionized water to the substrate;
a first nozzle moving device to move the coating-liquid nozzle to the center of the substrate;
a second nozzle moving device to move the deionized-water nozzle to the center of the substrate;
a first opening/closing valve provided in a coating-liquid supply conduit connecting the coating-liquid nozzle to a coating-liquid source;
a second opening/closing valve provided in a deionized-water supply conduit connecting the deionized-water nozzle to a deionized-water source; and
a controller to control rotational driving of the rotation device, driving of the first and second nozzle moving devices, and opening/closing of the first and second opening/closing valves,
wherein the controller controls the rotation device to rotate the substrate at low speed of a first rotation speed and controls the second nozzle moving device and the second opening/closing valve to supply the deionized water to the center of the substrate so that a liquid pool of the deionized water is formed on the substrate,
the controller controls the first nozzle moving device and the first opening/closing valve to supply the coating liquid to the center of the substrate in a state where the substrate is rotated at the first rotation speed so that the water-soluble coating liquid is mixed with the deionized water,
the controller controls the rotation device to rotate the substrate at a second rotation speed higher than the first rotation speed so that the coating-liquid film is formed on the substrate, and
a supply amount of the coating liquid is set by controlling a time ratio of mixing the coating liquid with the deionized water to forming the coating-liquid film.

10. The substrate coating apparatus of claim 9, wherein the time ratio of mixing the coating liquid with the deionized water to forming the coating-liquid film ranges from 1:3 to 3:1.

11. The substrate coating apparatus of claim 9, wherein the first rotation speed ranges from 10 rpm to 50 rpm, and the second rotation speed ranges from 2000 rpm to 4000 rpm.

12. The substrate coating apparatus of claim 7, wherein the coating liquid comprises a surfactant.
